(19) United States
(12) Patent Application Publication
(10) Pub. No.: US 2003/0224681 A1
(43) Pub. Date: Dec. 4, 2003

(54) Textile base material having an electromagnetic wave shielding

(75) Inventor: Michael Koch, Pinneberg (DE)

Correspondence Address: ROBERT W. BECKER & ASSOCIATES, Suite B, 11896 N. Highway 14, Tijeras, NM, 87059, US

(73) Assignee: Autoflug GmbH, Rellingen (DE)

(21) Appl. No.: 10/448,979

(22) Filed: May 30, 2003

(30) Foreign Application Priority Data
May 31, 2002 (EP) 02012105.9

(51) Int. Cl. B32B 27/04; B32B 27/12

(52) U.S. Cl. 442/131

(57) ABSTRACT

A textile base material serving to shield against electromagnetic waves is provided. Geometric structures are uniformly distributed on the base material such that they do not touch one another. Each geometric structure is made of a continuous filament of electrically conductive material. The dimensions of the geometric structures are coordinated with the half wavelength of the electromagnetic wave frequency that is to be selectively reflected.

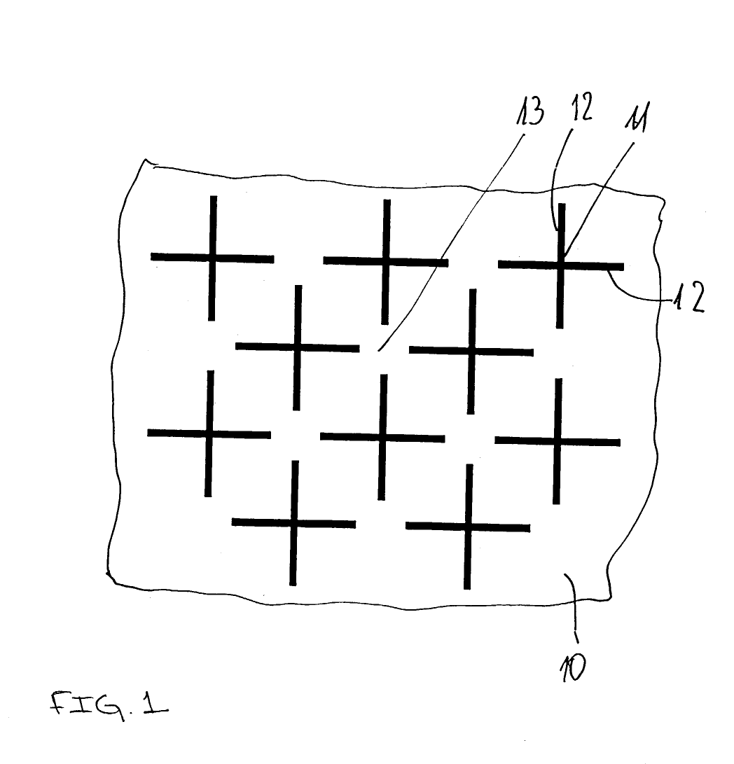

### BACKGROUND OF THE INVENTION

The present invention relates to a textile base material that serves for shielding against electromagnetic waves, and which has elements disposed thereon that are made of an electrically conductive material.

Such conductive textiles for protecting against electromagnetic fields are known and described, for example, in the publication by M. Koch entitled Conductive Textiles for Protecting Against Electromagnetic Fields, presented at the Denkendorf Symposium “Technical Textiles” in January 2001. In accordance therewith, such conductive textiles could be produced by a metallic coating of the fabric surface; a further manufacturing possibility is that the thread used for producing the fabric contains metallic filaments or metallic fibers.

In contrast thereto, the present invention proceeds from textile fabrics of conventional, non-conductive threads, to which are applied merely elements of an electrically conductive material. In this connection, the known textile fabrics concern bundles of metallic fibers that are woven into the fabric in the shape of a mesh, in other words, a metallic mesh that is applied to the textile fabric, and the mesh width of which is generally between 2 and 15 mm and is hence considerably greater than the mesh width of the carrier fabric.

Such a known textile fabric has the drawback that the applied metallic mesh is homogeneous in all directions, so that a more or less adequate reflection effect is established relative to all electromagnetic waves that occur. However, in practice requirements are encountered according to which the textile fabric should form a shielding only against electromagnetic waves having a certain selected frequency, while a shielding against waves having other frequencies is not necessary.

It therefore an object of the present invention to provide a textile fabric of the aforementioned general type which forms a frequency selective shielding of electromagnetic fields.

### BRIEF DESCRIPTION OF THE DRAWING

This object, and other objects and advantages of the present invention, will appear more clearly from the following specification in conjunction with the drawing, the single figure of which schematically shows the arrangement of geometrical shielding structures on a textile fabric.

### SUMMARY OF THE INVENTION

The basic concept of the present invention is that geometric structures are uniformly distributed on the textile base material in such a way that they do not contact one another, wherein each geometric structure is made of a continuous filament or thread of electrically conductive material, and wherein the dimensions of the geometric structures are coordinated with the half wavelength of the electromagnetic wave frequency that is to be selectively reflected.

The present invention takes into consideration the requirement of a frequency selective shielding in that the configuration of the geometric structures are coordinated with the half wavelength of the wave frequency that is to be selectively reflected. In this connection, the shielding effect is ensured in that for the manufacture of the geometric structures, a continuous filament or thread is used that is made of the electrically conductive material. Furthermore, the shielding is inventively achieved in that the geometric structures are disposed upon the fabric surface in a uniform distribution, yet without touching one another.

The present invention can be used on textile base materials, especially those that comprise a woven fabric, a knitted fabric or fleece.

Pursuant to one embodiment of the invention, the structures produced from the uninterrupted filament are woven into the textile base material and are integrated into the material surface.

Pursuant to one expedient inventive alternative, the structures produced from the uninterrupted filament are applied to the textile based material in an embroidery process. This has the advantage that the production of the textile base material, which comprises conventional, non-conductive thread, and the application of the shielding structures can be undertaken in successive manufacturing steps that can be carried out independently of one another.

In detail, it is provided that the mutual spacing of the structures relative to one another is on the one hand set in such a way that the electromagnetic waves that are to be reflected in a frequency selective manner, and are between the geometric structures, are not continuous, but on the other hand are minimized in such a way that an influencing of the frequency selective reflection characteristics of the structures relative to one another is precluded.

Pursuant to one exemplary embodiment of the invention, the geometric structures can respectively comprise a symmetrical cross having legs of the same length, whereby the total length of two aligned legs of the respective cross corresponds to the half wavelength of the wave frequency that is to be reflected.

Alternatively, each of the geometric structures can also comprise a circle.

Finally, it is also possible to embody the geometric structures as a triangle, whereby the present invention is in general applicable to all suitable shapes of geometric structures that enable a frequency selective shielding.

Further specific features of the present invention will be described in detail subsequently.

### DESCRIPTION OF PREFERRED EMBODIMENTS

Referring now to the drawing in detail, it can be seen from the single figure that crosses 11 are stitched or embroidered on a partially illustrated textile fabric 10 using a continuous filament or thread of an electrically conductive material; the crosses 11 have a symmetrical configuration, as well as a uniform, symmetrical distribution. The legs 12 of the crosses 11 each have the same length, which is dimensioned such that the total length of two aligned legs 12 corresponds to the half wavelength of the wave frequency that is to be reflected. Although not illustrated in further detail, each cross 11 that is embroidered upon the textile fabric surface 10 comprises a single, continuously embroidered filament, thereby avoiding an interruption of the conductivity of the cross structure within the cross 11.

The arrangement of the individual crosses 11 on the textile fabric surface 10 is such that although the legs 12 of two crosses 11 overlap one another, there is none-the-less no contact and hence no electrically conductive connection between the crosses 11. The minimum distance of the crosses 11 from one another is set such that an influencing of the frequency selective reflection characteristics of the crosses 11 relative to one another is precluded. In so doing, there result circular spaces 13 between the crosses 11.

The features of the subject matter disclosed in the present specification, the patent claims, the abstract and the drawing can be important not only individually but also in any desired combination with one another for realizing the various embodiments of the present invention.

The specification incorporates by reference the disclosure of European priority document 02012105.9 filed May 31, 2002.

The present invention is, of course, in no way restricted to the specific disclosure of the specification and drawing, but also encompasses any modifications within the scope of the appended claims.

What I claim is:

1. A textile base material for shielding against electromagnetic waves, comprising:
geometric structures uniformly distributed on the textile base material such that they do not touch one another, wherein each geometric structure is made of a continuous filament of electrically conductive material, and wherein the dimensions of the geometric structures are coordinated with the half wavelength of an electromagnetic wave frequency that is to be selectively reflected.

2. A textile base material according to claim 1, wherein said geometric structures of the uninterrupted filaments are woven into said textile base material and are integrated into a surface of said material.

3. A textile base material according to claim 1, wherein said geometric structures of the uninterrupted filaments are applied to said textile base material in an embroidery process.

4. A textile base material according to claim 1, wherein a spacing between said geometric structures is such that said frequency selective electromagnetic waves that are to be reflected, and are between the geometric structures, are not continuous, and wherein such spacing is minimized such that an influencing of the frequency selective reflection properties of the geometric structures relative to another is precluded.

5. A textile base material according to claim 1, wherein each of said geometric structures comprises a symmetrical cross having legs of the same length.

6. A textile base material according to claim 5, wherein the total length of two aligned legs of a respective cross corresponds to said half wavelength of said wave frequency that is to be reflected.

7. A textile base material according to claim 1, wherein each of said geometric structures is a circle.

8. A textile base material according to claim 1, wherein each of said geometric structures is a triangle.

9. A textile base material according to claim 1, wherein said base material is a textile fabric.

10. A textile base material according to claim 1, wherein said base material is a knitted textile material.

11. A textile base material according to claim 1, wherein said base material is a textile fleece.
